(19) United States
(12) Patent Application Publication
(10) Pub. No.: US 2013/0292331 A1
(43) Pub. Date: Nov. 7, 2013

(54) IONIC LIQUID RECOVERY AND PURIFICATION IN BIOMASS TREATMENT PROCESSES

(71) Applicants: Glenn Lipscomb, Perrysburg, OH (US); Sasidhar Varanasi, Toledo, OH (US); Praveen Paripati, Reston, VA (US); Anantharam P. Dadi, Toledo, OH (US)

(72) Inventors: Glenn Lipscomb, Perrysburg, OH (US); Sasidhar Varanasi, Toledo, OH (US); Praveen Paripati, Reston, VA (US); Anantharam P. Dadi, Toledo, OH (US)

(73) Assignees: THE UNIVERSITY OF TOLEDO, Toledo, OH (US); SUGANIT SYSTEMS, INC., Reston, VA (US)

(21) Appl. No.: 13/884,460

(22) PCT Filed: Nov. 9, 2011
(86) PCT No.: PCT/US11/60021

§ 371 Date: Jul. 30, 2013

Related U.S. Application Data
(60) Provisional application No. 61/411,878, filed on Nov. 9, 2010.

(51) Int. Cl. B01D 61/58

(52) U.S. Cl. CPC B01D 61/58
USPC 210/640; 210/641

(57) ABSTRACT

The invention includes a process for recovering ionic liquids used in the treatment of biomass for production of biofuels and other biomass-based products. Ionic liquid recovery and purification minimizes waste production and enhances process profitability.

### STATEMENT REGARDING FEDERALLY SPONSORED RESEARCH AND DEVELOPMENT

This invention was made with United States government support awarded by DOE Grant No. DE-FG02-08ER85225. The United States has certain rights in this invention.

### BACKGROUND OF THE INVENTION

1. Field of the Invention

The invention includes a process for recovering ionic liquids used in the treatment of biomass for production of biofuels and other biomass-based products. Ionic liquid recovery and purification minimizes waste production and enhances process profitability.

2. Description of Related Art

Lignocellulosic biomass is an attractive exemplary biomass feed-stock because it is an abundant, domestic, renewable source that can be harvested and converted to liquid transportation fuels, chemicals and polymers. The major constituents of lignocellulose are the following: (1) hemicellulose (20-30%), an amorphous polymer of five and six carbon sugars; (2) lignin (5-30%), a highly cross-linked polymer of phenolic compounds; and (3) cellulose (30-40%), a highly crystalline polymer of cellobiose (a glucose dimer). Cellulose and hemicellulose, when hydrolyzed into their sugars, can be converted into ethanol fuel through well established fermentation technologies. These sugars also foi111 the feedstocks for production of a variety of chemicals and polymers. The complex structure of biomass requires proper pretreatment to enable efficient saccharification of cellulose and hemicellulose components into their constituent sugars.

In lignocellulosic biomass, crystalline cellulose fibrils are embedded in a less well-organized hemicellulose matrix which, in turn, is surrounded by an outer lignin seal. Contacting naturally occurring cellulosic materials with hydrolyzing enzymes generally results in cellulose hydrolysis yields that are less than 20% of theoretically predicted results. Pretreatment of lignocellulosic biomass should be carried out prior to attempting enzymatic hydrolysis of the polysaccharides (cellulose and hemicellulose) in this biomass. Pretreatment refers to a process that converts lignocellulosic biomass from its native form, in which it is recalcitrant to cellulase enzyme systems, into a form for which cellulose hydrolysis is effective. Compared to untreated biomass, effectively pretreated lignocellulosic materials are characterized by an increased surface area (porosity) accessible to cellulase enzymes, and solubilization or redistribution of lignin. Increased porosity results mainly from a combination of disruption of cellulose crystallinity, hemicellulose disruption/solubilization, and lignin redistribution and/or solubilization.

Algae and Yeast are other examples of biomass sources that may be harvested and treated to yield particular products.

The use of ionic liquids for the treatment of certain sources of biomass has been reported. For example, dissolution and processing of pure cellulose using ionic liquids has previously been reported (Swatloski, R. P., U.S. Pat. No. 6,824,599; Holbrey, J. D., U.S. Pat. No. 6,808,557). An effective approach to mitigate the recalcitrance of cellulose to enzymatic hydrolysis by ionic liquid pretreatment was provided by Dadi, A., et al., (Applied Biochemistry and Biotechnology, vol. 136-140, p 407, 2007; Varanasi, S., U.S. Pat. No. 7,674,608). The isolation of cellulose from biomass by using ionic liquids (Fort, D. A., et al., Green Chemistry 9: 63-69, 2007) and the complete dissolution of biomass in ionic liquids (Vesa, M., International Patent Application Publication No. WO 2005/017001) have also been investigated. An effective approach for saccharifying the polysaccharide portions of biomass was provided by Varanasi et al. (U.S. Patent Application Publication No. U.S. 2008/0227162), which exploits the differing “affinities” of the three major components of biomass (i.e., lignin, hemicellulose and cellulose) towards ionic liquids, coupled with the unique capability of some ionic liquids in disrupting the crystallinity of the cellulose portion (by breaking the hydrogen-bonding structure). The method of Varanasi et al. requires neither the extraction of cellulose from biomass nor the dissolution of biomass in ionic liquid.

Due to the increased use of ionic liquids in biomass treatment methods, coupled with the costs associated with the use of ionic liquids, novel methods of recovering and purifying the ionic liquids used for biomass treatment methods are desirable.

### BRIEF SUMMARY OF THE INVENTION

The invention includes methods for recovering ionic liquids used in the treatment of biomass sources for the production of biofuels, chemicals, and other biomass-based products. Ionic liquid recovery and purification minimizes waste production and enhances process profitability.

### BRIEF DESCRIPTION OF THE DRAWING

FIG. 1 illustrates one example of a lignocellulosic biomass pretreatment process.

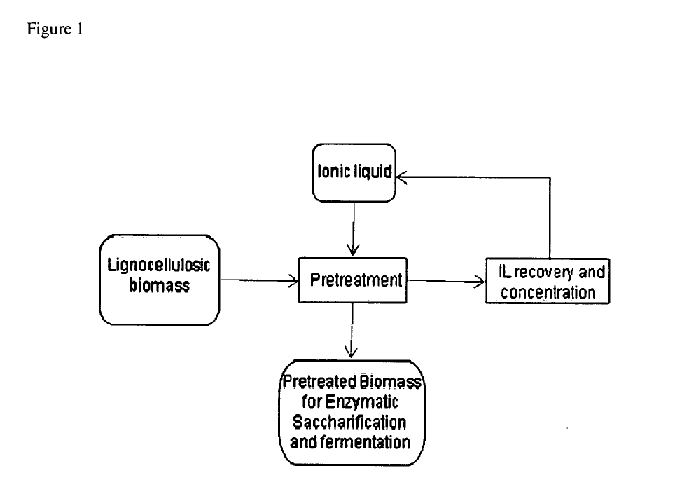

FIG. 2 illustrates one embodiment of the ionic liquid recovery and purification process.

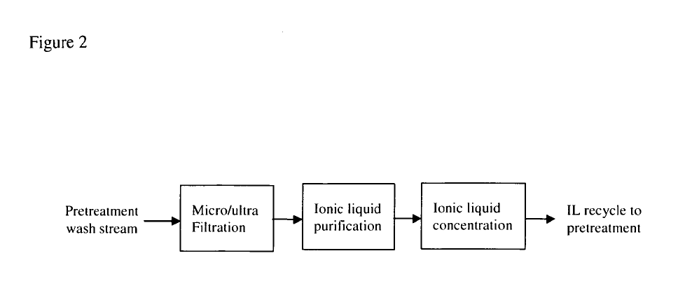

FIG. 3 illustrates the changes in concentration of the feed and concentrate streams of Example 1.

FIG. 4 illustrates a generic imidazolium-based ionic liquid structure.

FIG. 5 illustrates a generic pyrridinium-based ionic liquid structure.

FIG. 6 illustrates a schematic of ethanol production from biomass via the sugar platform.

FIG. 7 illustrates vapor liquid equilibrium (VLE) data for IL-water binary system at 60, 80 and 100° C.

### DETAILED DESCRIPTION OF PREFERRED EMBODIMENTS

It is to be understood that this invention is not limited to the particular methodology, protocols, and reagents described, as such may vary. It is also to be understood that the terminology used herein is for the purpose of describing particular embodiments only, and is not intended to limit the scope of the present invention which will be limited only by the appended claims.

As used herein the singular forms “a”, “and”, and “the” include plural referents unless the context clearly dictates otherwise. All technical and scientific terms used herein have the same meaning as commonly understood to one of ordinary skill in the art to which this invention belongs unless clearly indicated otherwise.

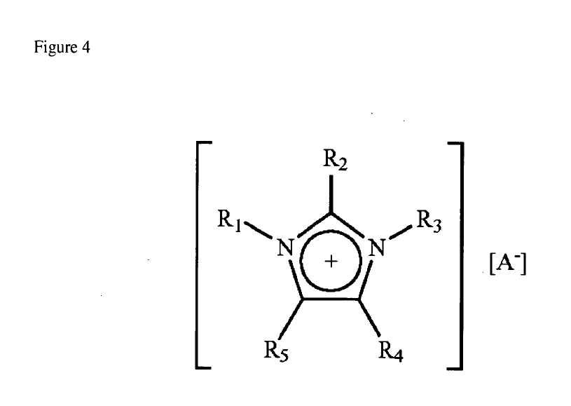

As used herein, the term “ionic liquid”, “IL” or similar is intended any ionic liquid capable of disrupting the hydrogen bonding structure of cellulose or hemicellulose to reduce the crystallinity of cellulose. The literature documents the synthesis of a wide range of ILs, and many are effective for example in lignocellulosic biomass pretreatment. The ILs may be categorized based on the structure of the cations or anions. Ionic liquids used in biomass treatment strategies are represented by a cation structure that includes imidazolium, pyrroldinium, pyridinium, phosphonium, or ammonium, and all functionalized analogs thereof. For example, the structure as shown in FIG. 4 wherein each of R₁, R₂, R₃, R₄, and R₅ is hydrogen, an alkyl group having 1 to 15 carbon atoms or an alkene group having 2 to 10 carbon atoms, wherein the alkyl group may be substituted with sulfone, sulfoxide, thioether, ether, amide, hydroxyl, or amine and wherein A is a halide, hydroxide, formate, acetate, propionate, butyrate, any functionalized mono- or di-carboxylic acid having up to a total of 10 carbon atoms, succinate, lactate, aspartate, oxalate, trichloroacetate, trifluoroacetate, dicyanamide, or carboxylate.

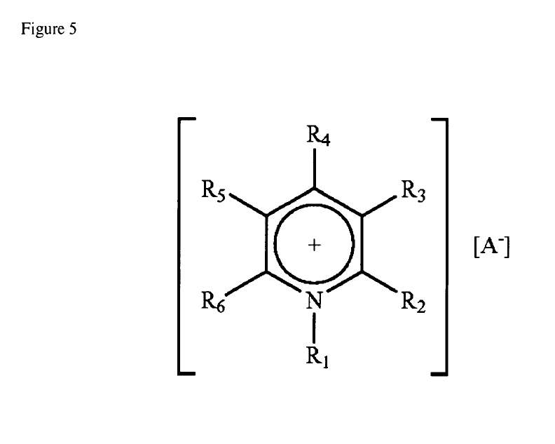

Another example of the structure of IL is shown in FIG. 5 wherein each of R₁, R₂, R₃, R₄, R₅, and R₅ is hydrogen, an alkyl group having 1 to 15 carbon atoms or an alkene group having 2 to 10 carbon atoms, wherein the alkyl group may be substituted with sulfone, sulfoxide, thioether, ether, amide, hydroxyl, or amine and wherein A is a halide, hydroxide, formate, acetate, propanoate, butyrate, any functionalized mono- or di-carboxylic acid having up to a total of 10 carbon atoms, succinate, lactate, aspartate, oxalate, trichloroacetate, trifluoroacetate, dicyanamide, or carboxylate. The halide can be a chloride, fluoride, bromide or iodide.

In another embodiment, an ionic liquid mixture with a composition described by

Equation 1 can be used:

$${\sum }_{n = 1}^{20} {{[ {C}^{+} ]}_{n} [ {A}^{-} ]}_{n}$$

C⁺ denotes the cation of the IL and A⁻ denotes the anionic component of the ionic liquid in Equation 1. Each additional ionic liquid added to the mixture may have either the same cation as a previous component or the same anion as a previous component, or differ from the first only in the unique combination of the cation and anion. For example, consider below the five component mixture of ionic liquids in which common cations and anions are used, but each individual IL component is different:

[BMIM⁺][Cl⁻]+[BMIM⁺][PF₆₋]+[EMIM⁺][Cl⁻]+[EMIM⁺][PF₆₋]+[EMIM⁺][BF₄⁻]

The final mixture of ionic liquids will vary in the absolute composition as can be defined by the mole percent of various functionalized cations and anions. Therefore, the mixture shall be comprised of varying weight percentages of each utilized component, as defined by Equation 1.

Ionic liquids have extremely low volatility and when used as solvents, they do not contribute to emission of volatile components. In this sense they are environmentally benign solvents. ILs have been designed to dissolve cellulose and lignocellulose. Following dissolution, cellulose can be regenerated by the use of anti-solvents. However, the complete dissolution of lignocellulosic materials (particularly woods) in ILs is harder and, even partial dissolution, requires very long incubation of biomass in IL at elevated temperatures. Even then, a high yield of cellulose is not generally achieved after regeneration (Fort, D. A. et al., 2007, Green. Chem.: 9, 63).

As used herein, the term “biomass” is intended any source of cellulose and/or hemicellulose that may be harvested and utilized in conjunction with an ionic liquid in a treatment process in order to obtain useful products. Non-limiting examples of biomass include, but are not limited to, lignocellululosic biomass including agricultural (e.g., corn stover), forestry residues (e.g. sawdust), herbaceous (e.g., switch grass), and wood (e.g. poplar trees) crops, algae such as algal cultures, and yeast such as yeast cultures.

Treatment of biomass in processes involving the use of ionic liquids may result in the creation of small organics and particulate matter from the biomass, and the mixture of ionic liquids and water. Recovery and recycle of ionic liquid and water from a biomass treatment fluid requires processes that remove insoluble particulate matter and separate solutes of non-ionic nature with a wide range of polarities. Membrane separation processes may be used effectively for these separations and in combination offer the potential for recycle of water and ionic liquid.

### Ionic Liquid Recovery and Purification

The invention includes methods for recovering ionic liquids used in the treatment of biomass for the production of biofuels, chemicals, and other biomass-based products. In one embodiment of the invention, the ionic liquid recovery and purification method comprises, or alternatively consists of, performing one or more membrane filtration steps on an ionic liquid-containing fluid, followed by a purification step, and then a concentration (or liquid separation) step. Each of these steps is discussed in greater detail below.

Membrane Filtration.

Membrane filtration removes particulate matter ranging in size from microns to nanometers based on physical size differences. Microfiltration, ultrafiltration, and nanofiltration processes remove progressively smaller material. A combination of these processes may be used to remove suspended particulate matter and bio-macromolecular solutes from fluids such as spent process streams prior to further purification and recycle. Removal is critical to minimize fouling in subsequent processing steps.

In one embodiment of the invention, one or more of the microfiltration, ultrafiltration, and nanofiltration processes may be repeated one or more times or combined.

Ionic Liquid Purification.

The ionic liquid stream produced by the filtration step may contain ionic liquid, water and solutes of comparable size to the ionic liquid and water. In one embodiment of the invention, the ionic liquid purification step is performed using electrodialysis. Electrodialysis processes permit removal of the non-ionic solutes from this stream. Ionic species pass through a series of cation and anion exchange membranes under the influence of an applied electric potential. In one embodiment of the invention, the electrodialysis is performed at a temperature between about 25° C. to about 80° C. Electrodialysis allows recovery and concentration of the ionic liquid.

Ionic Liquid Concentration (or Liquid Separation).

The ionic liquid wash may contain one or more additional solvents used in biomass treatment. Common solvents include, but are not limited to, water and alcohols. Recycle and reuse of ionic liquid requires removal of these additional solvents to reconcentrate the ionic liquid. Typically, ionic liquid concentrations in excess of 90% are required to maintain activity. Ionic liquid concentration methods include membrane dehydration, reverse osmosis, and membrane pervaporation.

Thermal processes that separate fluids based on differences in equilibrium vapor pressure are used widely in the chemical process industry. Distillation effectively separates species with large differences in vapor pressure. However, it is less effective for mixtures of species with small difference in boiling points, form azeotropes, or show highly non-ideal solution behavior.

These mixtures membrane separation processes based on differences in chemical potential offer unique advantages. The membrane selectively permeates one of the species to increase its concentration in the permeate. Membrane processes are not limited by equilibrium behavior and can be driven by using a sweep that increases the chemical potential driving force for transport across the membrane. Membrane modules are designed to provide efficient contacting between the feed and sweep. Preferably, the membrane materials used are chemically inert in nature.

Membranes for the processes described here may be produced in flat sheet, tubular, or hollow fiber shapes. The membranes may be formed from organic or inorganic materials that provide the required separation characteristics and are stable in the chemical and thermal environment of the process. Incorporation of the membranes in spiral wound or hollow fiber modules permits effective contacting with process streams.

Reverse osmosis may be used to concentrate biomass treatment chemicals by selectively permeating water or other solvents. For example, reverse osmosis membranes possess a pore and chemical structure that inhibit the transport of IL ions relative to the solvent.

Membrane pervaporation is an alternative for the concentration and recovery of biomass treatment chemicals. In pervaporation processes, a sweep contacts a liquid feed across a membrane. The membrane permits selective transport of one component of the liquid mixture to the sweep. Alternatively, a vacuum may be used to reduce the permeant partial pressure. Such pervaporation processes may utilize membranes that also are used for membrane gas or vapor dehydration.

Pervaporation is an attractive process for the recovery of ionic liquid from mixtures with water or other process solvents since ionic liquids are non-volatile and cannot be removed by vaporization into the sweep.

In a preferred embodiment of the invention, the recovery and purification process comprises, or alternatively consists of, microfiltration or ultrafiltration, followed by electrodialysis and then membrane dehydration.

In another preferred embodiment of the invention, the recovery and purification process comprises, or alternatively consists of, microfiltration or ultrafiltration, followed by electrodialysis and then membrane pervaporation.

In another embodiment of the invention, the method includes one or more additional thermal separation processes that are performed after the ionic liquid concentration step. Additional thermal separation processes include, but are not limited to, mechanical vapor recompression, thermal vapor recompression, thin film evaporation, multi-effect distillation, or multi-stage flash. One or more of these thermal separation processes may be combined as additional steps in the method.

In another preferred embodiment of the invention, the recovery and purification process comprises, or alternatively consists of, microfiltration or ultrafiltration, followed by electrodialysis, membrane dehydration, and then thermal vapor recompression.

In another preferred embodiment of the invention, the recovery and purification process comprises, or alternatively consists of, microfiltration or ultrafiltration, followed by electrodialysis, membrane dehydration, and then mechanical vapor recompression.

In another preferred embodiment of the invention, the biomass treatment fluid is obtained from a lignocellulosic source and the recovery and purification process comprises, or alternatively consists of, microfiltration or ultrafiltration, followed by electrodialysis and then membrane dehydration.

In another preferred embodiment of the invention, the biomass treatment fluid is obtained from an algal source and the recovery and purification process comprises, or alternatively consists of, microfiltration or ultrafiltration, followed by electrodialysis and then membrane dehydration.

In another preferred embodiment of the invention, the biomass treatment fluid is obtained from a lignocellulosic source and the recovery and purification process comprises, or alternatively consists of, microfiltration or ultrafiltration, followed by electrodialysis, membrane dehydration, and mechanical vapor recompression.

In another preferred embodiment of the invention, the biomass treatment fluid is obtained from an algal source and the recovery and purification process comprises, or alternatively consists of microfiltration or ultrafiltration, followed by electrodialysis, membrane dehydration, and mechanical vapor recompression.

In another preferred embodiment of the invention, the biomass treatment fluid is obtained from a lignocellulosic source and the recovery and purification process comprises, or alternatively consists of, microfiltration or ultrafiltration, followed by electrodialysis, membrane dehydration, and thermal vapor recompression.

In another preferred embodiment of the invention, the biomass treatment fluid is obtained from an algal source and the recovery and purification process comprises, or alternatively consists of, microfiltration or ultrafiltration, followed by electrodialysis, membrane dehydration, and thermal vapor recompression.

Current methods to break-down biomass into simple sugars for fermentation constitute the core barrier to producing bio-based ethanol with limited energy and water input and waste output. A promising ionic liquid pretreatment process was developed that substantially improves the efficiency of saccharification (hydrolysis of sugar polymers into monomeric sugar) of cellulose (the most recalcitrant biomass component) and hemicellulose [1-4]. Ionic liquids (ILs) are non-derivitizing solvents of cellulose [5, 6] that efficiently disrupt its structure without production of fermentation inhibitors. Ionic liquids are composed entirely of ions but are distinguished from common salts such as NaCl or LiCl (melting points of 801 and 601° C., respectively) by melting points of ˜100° C. or lower. ILs have negligible vapor pressure, resulting in low volatility, and are often considered as ‘green’ chemicals due to their low impact on air quality.

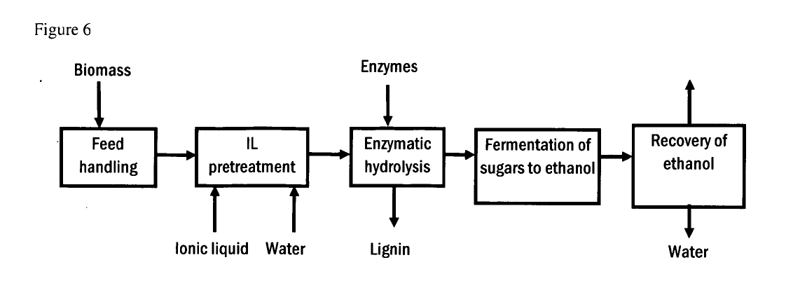

Production of bio-fuels through a hydrolysis/fermentation route (as opposed to gasification processes) typically consists of four major steps—(i) pretreatment, (ii) hydrolysis, (iii) fermentation and (iv) distillation and solids recovery (FIG. 6). The pretreatment process is currently the costliest part of the production process and also has a large impact on the production system as it affects the downstream steps. To meet the targets for bio-based alcohol production, large quantities of biomass must be processed. This will require large volumes of ionic liquids being used in our process. Process economics require special attention to the recovery and reuse of IL. Additionally, water is used as a solvent throughout the process. Water usage is greater than ionic liquid usage so water recycle is equally desirable from the economic stand point. Recovery and recycle of IL and water from biomass wash-streams after pretreatment will require technologies that can remove IL from water.

### Concentration of Recovered IL for Reuse

The effectiveness of IL in disrupting biomass structure is highly dependent on its moisture content. At moisture levels exceeding 6% (w/w), IL's effectiveness begins to diminish. Hence we have been faced with a situation where the IL-water solutions need to be concentrated from about 60% water to <5% water content, before the IL could be reused. Typically, thermal evaporative separation methods such as distillation and multi-effect evaporators are used. The energetics of these processes and the associated economics are governed by the vapor pressure of water in IL-water mixtures. There is not enough information in literature on the Vapor-Liquid-Equilibrium (VLE) of IL-water systems. Accordingly, we developed a new thermo-gravimetric technique to measure the vapor pressure water in IL-water mixtures. Using this data, we were able to assess the variation of vapor pressure of water with its concentration.

### Phase Equilibrium Data for IL-Water to Design an Evaporative Separation System

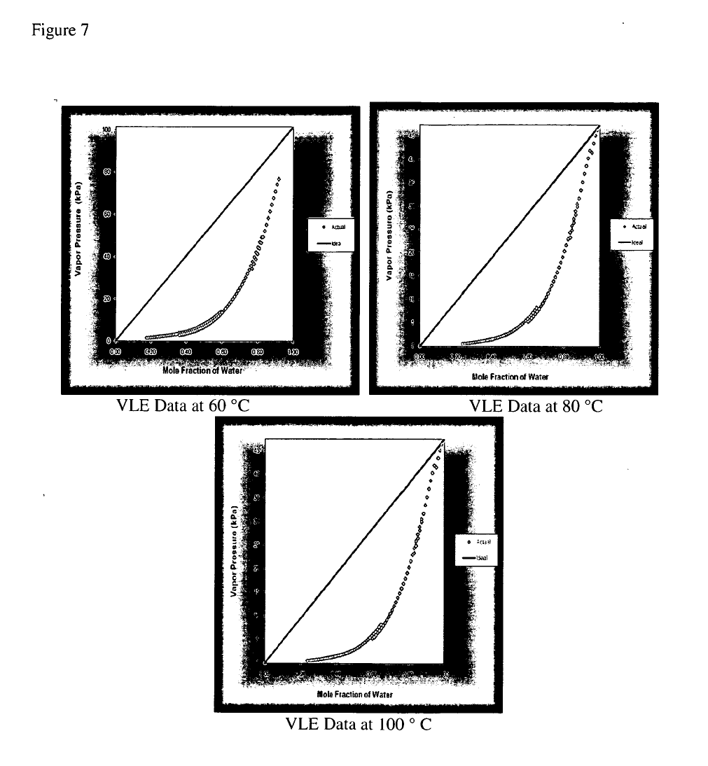

The thermo-gravimetric method developed by us takes advantage of the fact that ILs are non-volatile, and hence the vapor phase above an IL-water mixture comprises only water vapor. The accuracy of the method was established by checking the vapor pressures measured by the method with the literature values of systems for which VLE data exists. The VLE data measured for the IL-water system, Ethyl methyl imidazolium acetate-Water, at various temperatures are shown in FIG. 7. As can be seen in the figure, a strong negative deviation from Raoult's Law was observed for the IL-Water system and the driving force for separation diminished drastically as the mole fraction of water approached 0.4. This implies that separation of water from IL will require huge energy inputs with the regular evaporative separation schemes.

This observation prompted us to investigate approaches that have the potential to minimize the energy requirements to separate IL from water. After considerable exploration, we concluded that the technique of “Membrane Dehydration” will be a viable alternative.

Given the VLE diagrams at various temperatures in FIG. 7, and significant reduction in viscosity of ionic liquids with increase in temperatures, we conclude that membrane dehydration, either in flat sheet configurations, hollow fiber configurations or spiral wound module configuration will provide higher water flux and consequently better separation at high operating temperatures. Consequently, membrane dehydration units that are made of chemically inert material are good candidates for use in our dehydration step. Examples of such units include cyramic-supported polyimide membranes (these can safely operate at 95° C., for extended periods), chemically inert PEEK-SEP hollow fiber membranes (Porogen), high temperature chemically inert membrane dehydration units for ethanol water or oil and water and similar demanding separation applications (manufacturers like MTR, CM-Celfa for example).

### Membrane Dehydration System

Membrane dehydrators remove water by selectively permeating water across a membrane. However, the driving force for transport is provided by maintaining a concentration or temperature difference across the membrane instead of pressurizing the feed. Additionally, the water is removed as a vapor instead of a liquid. A concentration difference can be maintained by contacting one side of the membrane with dry air. Additionally, the liquid feed can be heated to create a temperature difference across the membrane. Our experiments indicate ionic liquid solutions can be concentrated significantly with no loss of ionic liquid; since the vapor pressure of the ionic liquid is nearly zero. Membrane dehydration is preferred to distillation or vaporization processes because rates of water removal are not limited by the equilibrium vapor pressure of water and membrane contactors provide more than an order of magnitude greater surface area per unit volume than plate or packed bed columns.

IL-wash solutions were concentrated to more than 98% (w/w) using an energy efficient membrane dehydration system. The ability to recover and recycle IL economically with membrane dehydration will significantly lower the energy requirements associated with IL reuse and enhance the commercialization prospects of ionic liquid pretreatment process.

In order to practically implement IL water separation via membrane dehydration, larger modules of 2 inch diameter will be built and tested. The membranes will be evaluated at different conditions (temperature, vacuum, air sweep rate) and their ruggedness tested with respect to Ionic liquids (Phase I). Promising modules will be scaled up further to test at the pilot scale facility over a longer period of time in preparation for demonstration scale facility (Phase II) The assembled team has successfully worked together and has the experience and expertise in engineering and membrane chemistry to deliver a viable ionic liquid water separation process.

The membrane dehydration module development to recycle ionic liquid holds promise for significant cost reduction of lignocellulose conversion to bioethanol. It not only allows the recycling of IL and water but also decreases the waste output. The ability to recover and recycle IL economically with this technique will substantially minimize the energy requirements in the commercialization of ionic liquid pretreatment for ethanol production from lignocellulosic biomass.

Moreover Ionic liquids are a new class of nonvolatile solvents that exhibit unique solvating properties. Because of their extremely low volatility ionic liquids are expected to have minimal environmental impact compared to most other volatile solvent systems.

### Membrane Dehydration Data:

IL Liquid flow rate at 60 or 75° C.: 1 liter/min
Dry air flow rate: 1 scfm
Vacuum pulled out from air outlet: 10 inches Hg

IL Dehydration data

| | | Temp of | | |
|---|---|---|---|---|
| Volume | Time | IL | Evaporation rate | IL Cone |
| (ml) | (hr) | ° C. | ml/hr | % |
| 3750 | 0 | 75 | | 50.00% |
| 3650 | 1 | 75 | 100 | 51.37% |
| 3600 | 1 | 75 | 50 | 52.08% |
| 3350 | 4 | 75 | 71 | 55.97% |
| 2900 | 12 | 60 | 38 | 64.66% |
| 2800 | 2 | 75 | 67 | 66.96% |
| 2760 | 1 | 75 | 40 | 67.93% |
| 2700 | 2 | 75 | 30 | 69.44% |
| 2600 | 2 | 75 | 50 | 72.12% |
| 2500 | 3 | 75 | 40 | 75.00% |
| 2475 | 1 | 75 | 25 | 75.76% |
| 2400 | 3 | 75 | 25 | 78.13% |
| 2225 | 11 | 60 | 16 | 84.27% |
| 2200 | 2 | 75 | 17 | 85.23% |
| 2000 | 12 | 60 | 17 | 93.75% |
| 1850 | 13 | 60 | 12 | 101.35% |

### REFERENCES

1. Varanasi, S., et al., Biomass Ionic Liquid Pretreatment: Patent Pending.
2. Varanasi, S., C. Schall, and A. P. Dadi, Saccharifying Cellulose, University of Toledo: U.S. Pat. No. 7,674,608, Issued: April 2010.
3. Dadi, A., C. A. Schall, and S. Varanasi, Appl. Biochem. Bioteehnol., 2007. 137: p. 407-422.
4. Dadi, A. P., S. Varanasi, and C. A. Schall, Biotechnology and Bioengineering, 2006. 95(5): p. 904-910.
5. Swatloski, R. P., R. D. Rogers, and J. D. Holbrey, Dissolution and processing of cellulose using ionic liquids, in Patent Application 20030157351. 2002: USA.
6. Swatloski, R. P., et al., Dissolution of cellulose with ionic liquids. J. Am. Chem. Soc., 2002. 124: p. 4974-4975.

The above description of various illustrated embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize. The teachings provided herein of the invention can be applied to other purposes, other than the examples described above.

These and other changes can be made to the invention in light of the above detailed description. In general, in the following claims, the terms used should not be construed to limit the invention to the specific embodiments disclosed in the specification and the claims. Accordingly, the invention is not limited by the disclosure, but instead the scope of the invention is to be determined entirely by the following claims.

The invention may be practiced in ways other than those particularly described in the foregoing description and examples. Numerous modifications and variations of the invention are possible in light of the above teachings and, therefore, are within the scope of the appended claims.

The entire disclosure of each document cited (including patents, patent applications, journal articles, abstracts, manuals, books, or other disclosures) in the Background of the Invention, Detailed Description, and Examples is herein incorporated by reference in their entireties.

The following examples are put forth so as to provide those of ordinary skill in the art with a complete disclosure and description of how to make and use the subject invention, and are not intended to limit the scope of what is regarded as the invention. Efforts have been made to ensure accuracy with respect to the numbers used (e.g. amounts, temperature, concentrations, etc.) but some experimental errors and deviations should be allowed for. Unless otherwise indicated, parts are parts by weight, molecular weight is average molecular weight, temperature is in degrees centigrade; and pressure is at or near atmospheric.

### EXAMPLES

### Example 1

### Micro/Ultrafiltration and Electrodialysis

The ionic liquid EMIMAc (1-ethyl 3-methyl imidazolium acetate) wash obtained from a poplar pretreatment process was filtered through micro/ultra filtration and purified with electrodialysis (ED). The ED feed (initial concentration 33% IL) was dialyzed against an aqueous ionic liquid solution (initial concentration 8%).

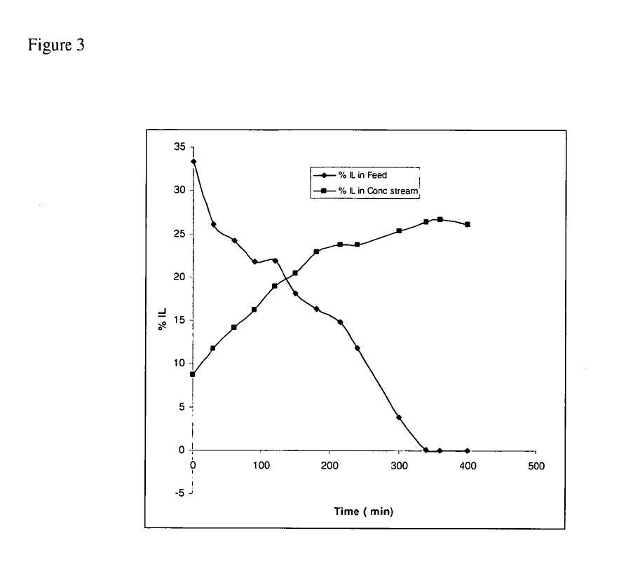

The changes in concentration of the feed and concentrate streams are illustrated in FIG. 3. After 350 minutes, the feed IL concentrate dropped to zero (below detection limit using liquid chromatography) and the concentrate stream increased to slightly greater than 25%. Consequently, IL recovery is nearly 100%. ¹H NMR of the ED-purified ionic liquid showed no changes in the spectra indicating the ionic liquid did not change in composition or structure during electrodialysis.

### Example 2

### Electrodialysis at High IL Concentration

An ED feed of 81% IL (1-ethyl 3-methyl imidazolium acetate) was electrodialyzed against the final concentrate produced in Example 1 to demonstrate the ability of ED to recover IL at high initial IL concentrations.

IL concentrations in the feed and concentrate as a function of operation time are provided in Table 1. After 450 minutes of operation, ED was stopped and the cell rinsed to remove all IL. Measurements of IL concentration in the final feed, concentrate, and rinse solutions indicated the mass balance for the process closed to within less than 1%.

TABLE 1
Concentration of feed and concentrate streams as a function of operation
time.

| Time (min) | Feed Concentration (%) | Concentrate Concentration (%) |
|---|---|---|
| 0 | 81.3 | 25.8 |
| 30 | 49.2 | 24.9 |
| 60 | 53.6 | 28.2 |
| 90 | 49.9 | 29.8 |
| 120 | 51.7 | 30.6 |
| 150 | 47.8 | 31.5 |
| 180 | 53.9 | 36.6 |
| 210 | 45.2 | 38.8 |
| 240 | 48.8 | 41.3 |
| 270 | 38.1 | 43.4 |
| 300 | 40.7 | 43.4 |
| 450 | 25.8 | 46.8 |

The final concentration of the concentrate is 47% while the feed was reduced from 81% to 26%. The use of ED to purify a salt from a feed with an initial high salt concentration contrasts sharply with more common ED applications in which the feed has a low salt concentration. High concentrations have not been encountered in past ED applications due to solubility limitations.

The ability to purify IL feed at high concentrations allows greater process flexibility and operation at IL concentrations that possess high electrical conductivity thereby increasing process efficiency.

### Example 3

### IL Concentration with Reverse Osmosis (RO)

The results of a series of experiments using GE/Osmonics RO AG membranes are presented in Table 2. A Sepa CF membrane cell was used for the experiments. This unit provides 0.014 m² membrane area. Ionic liquid concentration was determined using liquid chromatography. The experiments were performed at room temperature.

For the given IL feed concentration of 5 wt %, the permeate contained approximately 0.3% IL for feed pressures ranging from 350 to 450 psi. The data confirm that RO can be used to concentrate IL.

TABLE 2
Retentate and permeate produced by reverse osmosis of IL-water mixtures.
For all experiments the feed concentration was 5.0 wt % and the feed flow rate was 10 ml/min.

| Feed Pressure | Retentate IL | Retentate flow | Permeate IL | Permeate flow |
|---|---|---|---|---|
| (psi) | wt % | (ml/min) | wt % | (ml/min) |
| 350 | 5.44 | 8.5 | 0.30 | 1.5 |
| 400 | 5.57 | 8.4 | 0.33 | 1.6 |
| 450 | 6.47 | 8.2 | 0.33 | 1.9 |

### Example 4

### Membrane Pervaporation with Air Sweep

An Osmonics RO AG membrane with a liquid feed of 30 ml/min and an air sweep feed rate of 15 L/min at a temperature of 40° C. was used to obtain the data in Table 3. The experiments were performed using an Osmonics Sepa CF test cell. The data are presented as water flux as a function of IL concentration. The data indicate the feed with an initial IL concentration of 23% could be concentrated to 81%.

TABLE 3
Water fluxes in membrane pervaporation with an air sweep.

| IL concentration (%) | Water flux (kg/hr/m²) |
|---|---|
| 22.8 | 0.142 |
| 26.1 | 0.138 |
| 33.1 | 0.122 |
| 36.7 | 0.126 |
| 39.0 | 0.119 |
| 47.4 | 0.086 |
| 51.7 | 0.081 |
| 56.5 | 0.065 |
| 57.7 | 0.041 |
| 62.1 | 0.043 |
| 67.5 | 0.032 |
| 70.6 | 0.022 |
| 73.3 | 0.011 |
| 77.0 | 0.009 |
| 80.9 | 0.000 |

The presence of water vapor in the air sweep inhibits water transport across the membrane. To remove water vapor, a commercial air dehydration membrane may be introduced into lines between a compressed air supply and the utilization of the membrane module for ionic liquid dehydration. To further concentrate ionic liquid, the compressed air flow rate through an air dehydration module may be reduced. In one embodiment, reducing the flow rate decreases the water concentration of the dried air leaving the module and enhances the recovery.

In another embodiment for viscous IL-water mixtures, the water concentration in the liquid adjacent to the membrane may decrease significantly due to concentration polarization. In this embodiment, increasing the liquid flow rate reduces concentration polarization and increases the water concentration at the membrane surface that drives transport across the membrane.

One or more of these embodiment may be combined to further increase the ionic liquid yield.

### Example 5

### Membrane Pervaporation with Air Sweep

An Osmonics RO AG membrane with a liquid feed of 60 ml/min and an air sweep feed rate of 6 L/min at a temperature of 40° C. was used to obtain the data in Table 4. The experiments were performed using an Osmonics Sepa CF test cell. The initial feed to the process was the IL product produced after the experiment described in Example 3 and additional experiments in which liquid and gas flow rates were varied to produce an 89% IL product stream.

The feed air was passed through a compressed air membrane dehydration module to lower the entering dew point of the gas and increase the driving force for water permeation. The data are presented as water flux as a function of IL concentration. The data indicate the feed with an initial IL concentration of 89% could be concentrated to nearly 97%.

TABLE 3
Water fluxes in membrane pervaporation with an air sweep.

| IL weight concentration (%) | Water flux (kg/hr/m²) |
|---|---|
| 88.9 | 0.0044 |
| 93.7 | 0.0043 |
| 94.7 | 0.0041 |
| 96.4 | 0.0031 |
| 96.9 | 0.0000 |

Increasing the liquid flow rate increases the maximum IL concentration to −97%. Optimization of liquid and gas flow rates may increase water fluxes further. No evidence for IL permeation across the dehydration membranes was found upon examination of the membranes after the dehydration experiments.

Any non-condensable gas may be used as this sweep. For example, helium, nitrogen, and argon may be used. The choice of sweep will depend on process economics.

### Example 6

### IL Effectiveness After Recovery, Purification, and Concentration

The effectiveness of the combined recovery and purification process was demonstrated by performing enzymatic hydrolysis of poplar pretreated with recycled EMIMAc. To produce the recycled IL, pristine IL was used for pretreatment and then recycled after microfiltration, ultrafiltration, electrodialysis, and pervaporation. The conversions of glucan and xylan using the recycled IL are compared to the conversions obtained with pristine IL in Table 4. Recycled IL yields conversions comparable to pristine IL.

TABLE 4
Glucan and xylan conversion with recycled and prisitine IL.

| IL Stream | Glucan conversion (%) | Xylan conversion (%) |
|---|---|---|
| Recycled | 92 | 40 |
| Pristine | 84 | 60 |

What is claimed is:

1. A method for recovering and purifying liquids used in biomass treatment processes, said method comprising the steps of:
a. processing a stream obtained from a biomass treatment process through membrane filtration;
b. processing said filtered stream through an electrodialysis device; and
c. separating liquids present in said stream by passing said stream through a membrane.

2. The method of claim 1, wherein said membrane filtration comprises microfiltration, ultrafiltration, or nanofiltration, or any combination of any two or all three of these processes.

3. The method of claim 1, wherein membrane dehydration is applied to achieve the membrane separation of liquids present in said stream.

4. The method of claim 1, wherein reverse osmosis is applied to achieve the membrane separation of liquids present in said stream.

5. The method of claim 1, wherein membrane pervaporation is applied to achieve the membrane separation of liquids present in said stream.

6. The method of claim 3, wherein said membrane dehydration is carried out with a non-condensable gas

7. The method of claim 6, wherein said non-condensable gas comprises helium, nitrogen, or argon.

8. The method of claim 1, wherein the electrodialysis is performed at a temperature between about 25° C. to about 80° C.

9. The method of claim 8, wherein the ionic liquid recovery is at least about 97% by weight.

10. The method of claim 5, wherein the process utilizes a vacuum, an air sweep comprising air, dried air, or other gas.

11. The method of claim 1, further comprising performing one or more thermal separation processes selected from mechanical vapor recompression, thermal vapor recompression, thin film evaporation, multi-effect distillation, or multi-stage flash.
